(19) United States
(12) Patent Application Publication
(10) Pub. No.: US 2005/0028647 A1
(43) Pub. Date: Feb. 10, 2005

(54) Method and apparatus for applying permanent ink

(75) Inventor: Wesley S. Sloan, Denison, TX (US)

Correspondence Address: JENKENS & GILCHRIST, PC, 1445 ROSS AVENUE, SUITE 3200, DALLAS, TX, 75202, US

(73) Assignee: Wesley S. Sloan, Denison, TX (US)

(21) Appl. No.: 10/723,763

(22) Filed: Nov. 26, 2003

Related U.S. Application Data
(60) Provisional application No. 60/429,598, filed on Nov. 27, 2002.
(60) Provisional application No. 60/452,480, filed on Mar. 5, 2003.

(51) Int. Cl. B43K 5/00

(52) U.S. Cl. 81/9.22

(57) ABSTRACT

A machine for reciprocating a needle has a frame having a contact point, an armature bar coupled to the needle, support means for supporting the armature bar on the frame for oscillation thereon, and electromagnet means supported on the frame for oscillating the armature. A control circuit is provided for energizing the electromagnetic means, with switching means coupled at one end to the armature bar for providing electrical contact between the control circuit and the electromagnetic means. Dampening means is provided for increasing the frequency of the oscillations of the armature bar.

### CROSS-REFERENCE

This application claims priority from U.S. provisional Application for Patent No. 60/429,598 filed on Nov. 27, 2002 and U.S. Provisional Application for Patent No. 60/452,480 filed Mar. 5, 2003, the disclosures of which are hereby incorporated by reference.

### BACKGROUND OF THE INVENTION

1. Field of the Invention

The present invention relates generally to the application of permanent ink and, more particularly, but not by way of limitation, to a method and apparatus facilitating the introduction of a pigment beneath the skin using a reciprocating needle for purposes of tattooing or cosmetic surgery.

2. History of the Related Art

The popularity of tattoos and tattoo parlors has grown considerably in recent years. Tattoo devices, machines and systems comprise, in general, a well known area of cosmetic technology. Among these is the oscillating relay type tattoo machine. For example, U.S. Pat. No. 4,159,659 to Nightingale discloses a tattooing device comprising a frame and multiple electromagnetic (EM) coils, an armature assembly, an interrupter switch which completes the circuit which changes the EM coil. The duty cycle of the machine, determined by the ratio of the open and closed contact times, can be adjusted by adjusting the voltage to the EM coil, or by adjusting the distance between the armature bar and interrupter switch. U.S. Pat. No. 6,282,987 to Moniz discloses a contact bar assembly for adjustment of the contact point on the frame of the oscillating relay type machine to adjust the speed of the reciprocating needle. U.S. Pat. No. 4,177,660, U.S. Pat. No. 5,054,339, and U.S. Pat. No. 5,401,242 to Yacowitz disclose a device using leaf springs and an electromagnetic coil.

Furthermore, a technical report by Elikon Device, Inc. (Report number 6, produced in 1997), and incorporated herein by reference, discloses that the front spring establishes the speed at which the armature bar will oscillate. The back spring secondarily determines the efficiency and operational characteristics of the front spring. There are basically four methods to adjust the duty cycle of a device as described herein. The first method is to adjust the contact point gap, which affects the open contact time of the machine, and is only useful for fine tuning. The second method is to adjust the amount of voltage applied to the coils which in turn adjusts the amount of magnetism created by the electromagnets. The third method is to adjust the hardness of the front spring, which, as discussed above has the greatest impact on the duty cycle of the traditional oscillating type machine. The fourth method is to adjust the hardness of the back spring. However, by changing the front and back spring, one must match the two sets so as to achieve maximum efficiency. Further, changing the springs is time consuming. Thus, there is a great need in the industry to quickly and reliably change the duty cycle of an oscillating type device.

Also, the oscillating type of machine may be noisy, and sometimes vibrating in the hand of the operator. Both characteristics may result in fatigue of the operator, thus making the hand of the operator less steady. Worse still, uneven lines or mistakes in tattoo or permanent make-up designs may be caused by a fatigued hand. The related art also describes various mechanisms and methods for reducing the noise of the traditional oscillating type of tattooing machine, and for reducing the vibrations thereof. For example, U.S. Pat. No. 4,204,438 to Binaris discloses placing a bushing in a needle housing for quieter operation. Further, U.S. Pat. No. 5,551,319 to Spaulding discloses achieving quieter operation through a synthetic housing.

There are a variety of problems with the traditional oscillating type of tattoo machine. The present invention addresses many of the aforementioned problems by the addition of a spring dampener attached to the front spring and an armature bushing attached to the electromagnets of an oscillating type of tattoo machine.

### SUMMARY OF THE INVENTION

The present invention relates to tattoo methods and apparatus. More particularly, the present invention relates to a method and apparatus for the application of permanent ink to the skin. Yet more particularly, the present invention relates to an apparatus and method for reciprocating a needle at varying speeds. In one aspect, the invention includes a machine for reciprocating a needle, comprising a frame having a contact point, an armature bar coupled to the needle, support means for supporting the armature bar on the frame for oscillation thereon, and electromagnet means supported on the frame for oscillating the armature. A control circuit is provided for energizing the electromagnetic means, as well as, switching means coupled at one end to the armature bar for providing electrical contact between the control circuit and the electromagnetic means. A dampener is also provided for increasing the frequency of the oscillations of the armature bar.

In a further aspect, the dampener comprises an elastomeric ring coupled to the frame and the switching means, an elastomeric wedge structure abutting the switching means and the top surface of the armature bar, and/or an elastomeric member coupled to the top surface of the electromagnetic means so as to dampen the vibrations caused by contact between the electromagnetic means and the armature bar.

The advantages of the addition of a dampener is that the duty cycle can be changed more efficiently, and the overall operation of the machine is quieter, thus reducing the stress on the operator. Further, with quieter operation, vibrations caused by contact between the armature and the EM coil will be reduced thus reducing the hand fatigue of the operator.

### BRIEF DESCRIPTION OF THE DRAWINGS

A more complete understanding of the method and apparatus of the present invention may be obtained by reference to the following Detailed Description, with like reference numerals denoting like elements, when taken in conjunction with the accompanying Drawings wherein:

FIG. 1A is an illustration of one embodiment of the ink application apparatus according to the principles of the present invention;

FIG. 1B is an enlarged illustration of a portion of the apparatus of FIG. 1A;

FIG. 2 is a photograph of one embodiment the ink application apparatus according to the principles of the present invention;

FIG. 3 is an illustration of an alternate embodiment of the spring dampener of the ink application apparatus according to the principles of the present invention;

FIGS. 4A-4C are an illustration of an alternate embodiment of the ink application apparatus incorporating a resistor/capacitor combination according to the principles of the present invention;

FIG. 5 illustrates another embodiment of the armature bar bushing; and

FIG. 6 is a perspective view of the machine including a resistor.

### DETAILED DESCRIPTION OF THE DRAWINGS

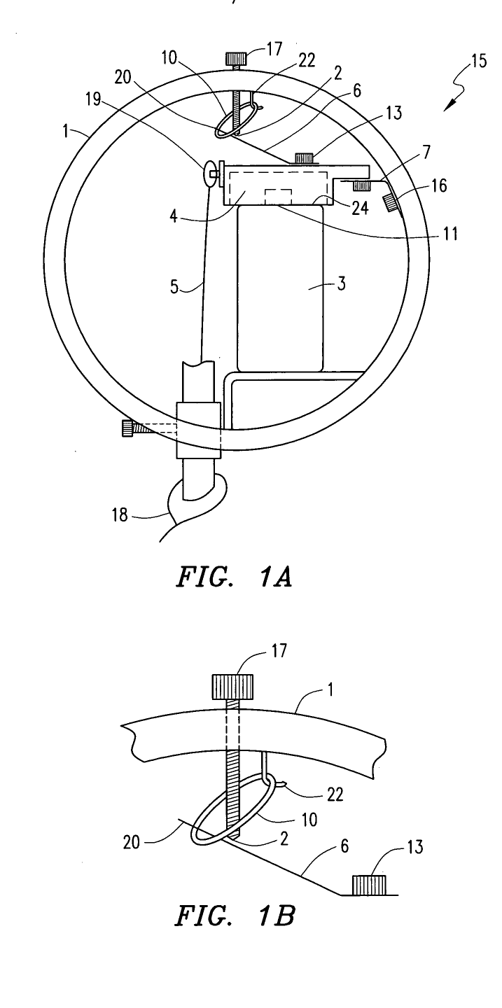

The novel and inventive aspects of the machine 15 of the present invention can be understood with reference to FIG. 1A, illustrating a side-elevational view of the present invention. The machine 15 generally comprises a grip 18 and a frame 1. Although the frame 1 is shown as being a particular size and orientation, it will be understood by one skilled in the art that various frames may be utilized in conjunction with aspects of the present invention. The frame 1 comprises an adjustable contact screw 17 having a coupling point 2 to a leaf spring 6. A spring dampener 10 is coupled to an upper portion 20 of the front leaf spring 6 and a coupling point 22 of the frame 1. The spring dampener 10 is discussed in greater detail below with reference to FIG. 1B.

Remaining with FIG. 1A, included within frame 1 are two electromagnetic (EM) coils (electromagnets) 3, an armature bar 4 coupled to a reciprocating needle 5 with coupling means 19, and the front leaf spring 6 and back leaf spring 7 are coupled to the armature bar 4 with coupling means 13. An armature bar bushing 11 comprised of an elastomeric material is coupled to an upper portion 24 of the electromagnets 3. The armature bushing 11 decreases the vibrations and noise of the machine 15. The armature bushing 11 assists in the return of the armature bar 4 to the starting position for a faster return time. The armature bushing 11 also reduces noise from the contact of the armature bar 4 and the electromagnets 3. The back leaf spring 7 is coupled to the frame 1 with coupling means 16. A circuit is formed between the electromagnets 3, the frame 1, and the front 6 and back 7 leaf springs which energize the electromagnets 3 to attract the armature bar 4, which in turn reciprocates the needle 5.

Still referring to FIG. 1A, in operation, the electromagnets 3 are first charged when the armature bar 4 is in the up position and the front leaf spring 6 is in contact with the contact point 2 (closed contact). When the electromagnets 3 are sufficiently charged, the armature bar 4 is pulled down, breaking the contact between the front leaf spring 6 and the contact point 2 (open contact), which in turn discharges the electromagnets 3. The armature bar 4 is released and the back leaf spring 7 returns the armature bar 4 to the starting position, with the front leaf spring 6 in contact with the contact point 2. The machine 15 has a duty cycle defined as the ratio of the closed and open contact times.

Referring now to FIG. 1B, a detailed illustration of the elastomeric spring dampener 10 as oriented around the front leaf spring 6 and coupling point 22 is shown. As previously described, the elastomeric spring dampener 10 is coupled to the coupling point 22 at one end, and an upper portion 20 of the front leaf spring 6 at the alternate end. The elastomeric spring dampener 10 holds the front leaf spring 6 in contact with the contact point 2 longer (increases closed contact times) and also brings the front leaf spring 6 back into contact quicker (decreases open contact times), thereby increasing the duty cycle of the machine 15.

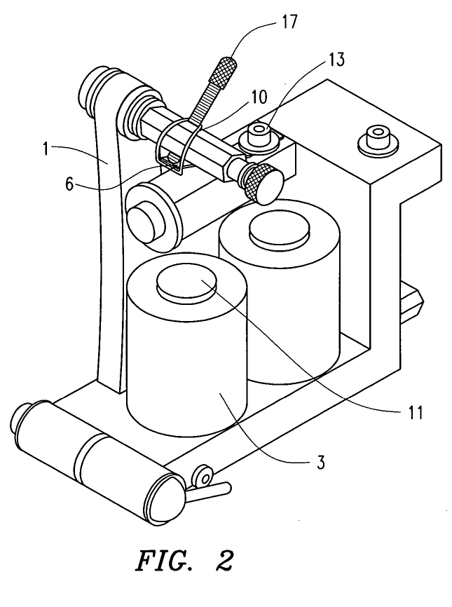

Referring now to FIG. 2, there is shown a photograph of one embodiment of the present invention. The needle 5 and grip 18 are not shown in order to further illustrate aspects of the inner workings of the machine 15. The elastomeric spring dampener 10, in an alternate embodiment of the present invention, is coupled to the contact screw 17 and the upper portion 20 of the front leaf spring 6. The armature bar bushing 11 is shown resting atop the electromagnets 3 to prevent vibrations from the armature bar 4 and assist the armature bar 4 in returning to the start position.

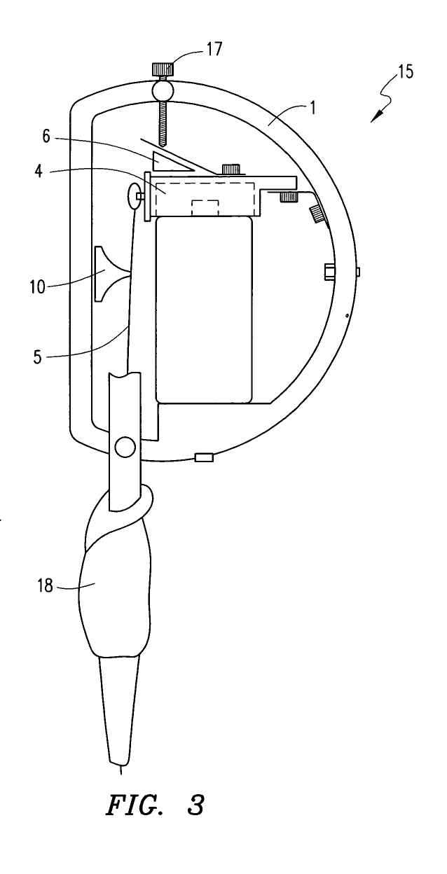

Referring now to FIG. 3, there is shown an alternate embodiment of the machine 15 of the present invention, incorporating a wedge as the elastomeric spring dampener 10. IN this embodiment, the elastomeric spring dampener 10 is formed as a wedge that contacts the needle 5. Although the elastomeric spring dampener 10 is placed in a different location than other embodiments, the elastomeric spring dampener 10 provides reduced vibration and an increased duty cycle similar to other embodiments.

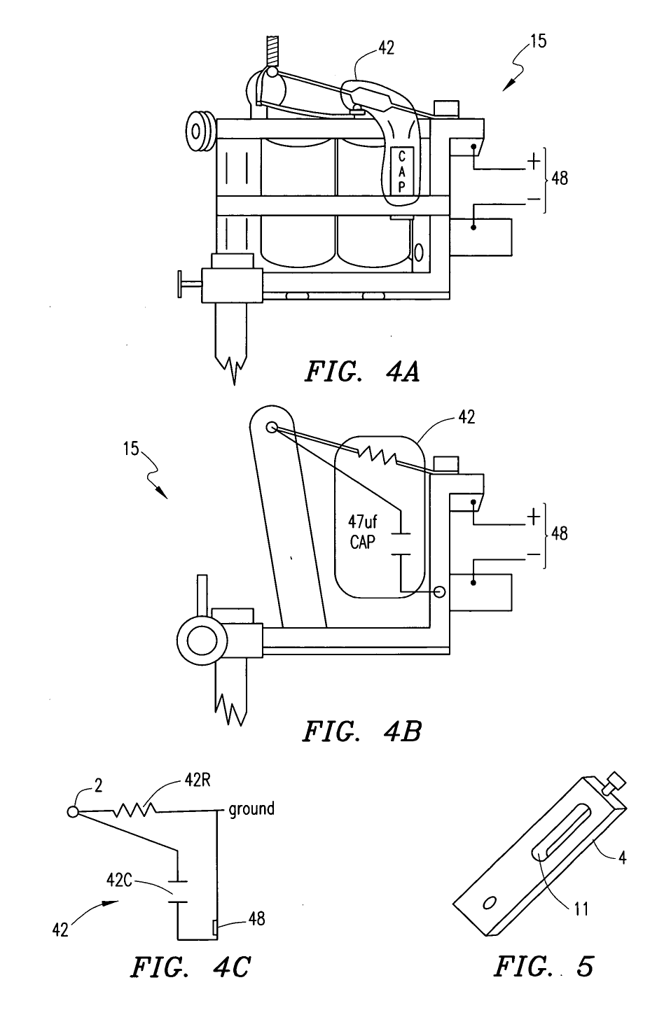

Referring now to FIGS. 4A, 4B, and 4C in combination, there is shown an alternate embodiment of the present invention illustrating a resistor-capacitor (RC) combination 42 coupled to the frame 1 and the contact point 2 of the embodiment illustrated in FIGS. 1-3. This embodiment may be used in conjunction with the elastomeric spring dampener 10 and armature bar bushing 11 previously described. The RC combination along with the elastomeric spring dampener 10 and armature bar bushing 11 enable the machine 15 to operate at a substantially greater duty cycle than without the RC combination 42. For example, with a 100 Ohm, 2%, 1 W resistor and a 47 uF 50V capacitor, the machine 15 exhibits an increase of 90 Hz in the duty cycle. Furthermore, by increasing the power input to the machine 15, duty cycles of well over 400 Hz may be obtained.

Referring specifically now to FIG. 4C, there is shown a schematic diagram of the resistor/capacitor combination 42 having a resistor 42R and a capacitor 42C. The resistor 42R connects the contact point 2 to ground, while the capacitor 42C connects the contact point 2 to a power source 48.

Referring now to FIG. 5, there is shown an alternate embodiment of the bushing 11 of FIGS. 1-3. In this embodiment, the armature bar bushing 11 is an elastomeric substance injected into a portion of the surface of the armature bar 4 contacting the electromagnetic coil 3. The preferred embodiment illustrates the armature bar bushing 11 as oval shaped, however other orientations and shapes are possible in conjunction with the present invention.

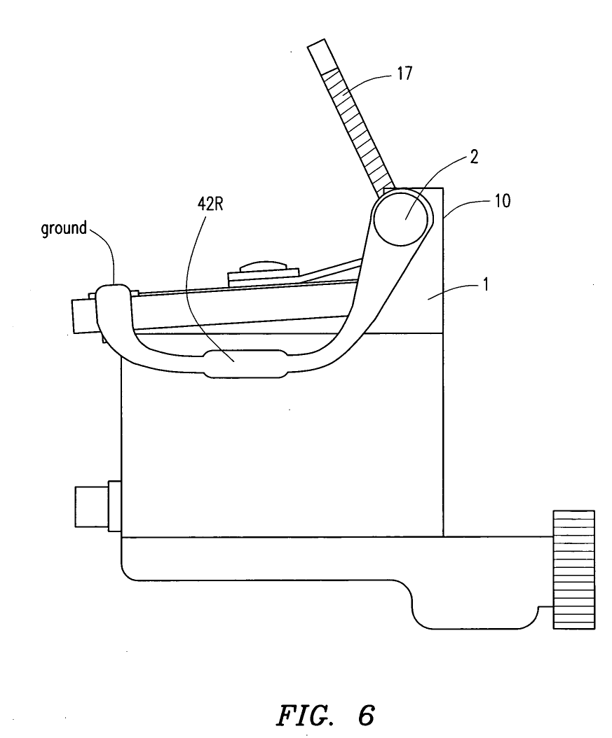

Referring now to FIG. 6, a perspective view of the machine 15 including the resistor 42R is illustrated. As previously described, the resistor 42R is connected between the ground and a contact point 2 of the frame 1. The resistor 42R provides an increase in the duty cycle of the machine 15 to provide faster bobbing of the needle 5. By increasing the speed of the needle 5, the tattoo may heal faster and cause less pain to one receiving a tattoo.

As described hereinabove, the advantages of the elastomeric spring dampener 10 and armature bushing 11 are that the duty cycle can be changed more efficiently, and the overall operation of the machine 15 is quieter, thus reducing the stress on the operator. Further, with quieter operation, vibrations caused by contact between the armature 4 and the electromagnet 3 will be reduced thus reducing the hand fatigue of the operator.

The previous description is of preferred embodiments for implementing the invention, and the scope of the invention should not necessarily be limited by this description. The scope of the present invention is instead defined by the following claims.

1. A tattoo machine, comprising:
a frame having a contact point;
an armature bar coupled to a needle;
a back spring operable to support said armature bar on said frame for oscillation thereof;
at least one electromagnetic coil supported on said frame operable to oscillate said armature bar thereof;
a control circuit operable to energize said at least one electromagnetic coil;
a front spring coupled to said armature bar and positioned to contact said contact point of said frame;
a resistor and a capacitor coupling said contact point to a power source; and
a dampener operable to increase the frequency of the oscillations of said armature bar;
wherein said armature bar oscillates between said contact point and said at least one electromagnetic coil in response to the energization of said at least one electromagnetic coil.

2. The machine of claim 1, wherein said dampener comprises an elastomeric ring coupled to said frame and said armature bar.

3. The machine of claim 2, wherein said dampener comprises an elastomeric wedge structure abutting said front spring and a top surface of said armature bar.

4. The machine of claim 3, wherein said dampener further comprises an elastomeric member coupled to said top surface of said at least one electromagnetic coil so as to dampen the vibrations caused by contact between said at least one electromagnetic coil and said armature bar.

5. A method for the application of permanent makeup using a machine incorporating a reciprocating needle coupled to an armature bar supported on a frame, said method comprising the steps of:
supporting said armature bar on said frame for oscillation thereof;
oscillating said armature bar having a spring thereon;
controlling the rate of oscillations of said armature bar with a dampener.

6. The method of claim 5, wherein the step of controlling the rate of oscillations of said armature bar with said dampener comprises the step of attaching an elastomeric ring to said frame and said armature bar.

7. The method of claim 6, wherein the step of controlling the rate of oscillations of said armature bar with said dampener comprises the step of attaching an elastomeric wedge structure abutting said spring and a top surface of said armature bar.

8. The method of claim 6, wherein the step of controlling the rate of oscillations of said armature bar with said dampener further comprises the step of attaching an elastomeric member to a top surface of said electromagnet.

9. The method of claim 6, wherein said step of oscillating said armature bar includes the steps of providing an electromagnet and inducing oscillations therewith.
